(19) United States
(12) Patent Application Publication
(10) Pub. No.: US 2021/0223164 A1
(43) Pub. Date: Jul. 22, 2021

(54) DETECTION SYSTEM

(71) Applicant: CARRIER CORPORATION, Palm Beach Gardens, FL (US)

(72) Inventors: Alan Matthew FINN, Hebron, CT (US); Srinivas RAVELA, East Hartford, CT (US); Michael J. BIRNKRANT, Wethersfield, CT (US)

(73) Assignee: Carrier Corporation, Palm Beach Gardens, FL (US)

(21) Appl. No.: 17/053,949

(22) PCT Filed: May 8, 2019
(86) PCT No.: PCT/US2019/031228

§ 371 Date: Nov. 9, 2020

Related U.S. Application Data
(60) Provisional application No. 62/670,160, filed on May 11, 2018.

(51) Int. Cl. G01N 21/17; G01V 8/12

(52) U.S. Cl. CPC G01N 21/1717; G01N 2021/1714; G01V 8/12

(57) ABSTRACT

A screening system includes a modulated light source, a wavelength-shifting filter, and a photosensor. The light source is operable to emit light into a screening region through which people or objects move. The photosensor is adjacent the screening region and is operable to emit sensor signals from scattered light received through the wavelength-shifting filter from interaction of the light with the people or objects in the screening region.

### CROSS-REFERENCE TO RELATED APPLICATION

This application claims benefit of U.S. Provisional Application No. 62/670,160 filed May 11, 2018.

### BACKGROUND

Screening systems are used at many locations to screen people and objects for safety purposes. For instance, screening has become typical at airports, concerts, sporting events, warehouses, ports, checkpoints, and the like. Screening may rely on devices such as metal detectors, swabs, electromagnetic wave scanners, millimeter and terahertz wave imagers to detect explosives, narcotics, toxic materials, weapons, and other security threats. Such devices can be large in size, slow, intrusive, inaccurate, and expensive.

### SUMMARY

A screening system according to an example of the present disclosure includes a modulated light source operable to emit light into a screening region through which people or objects move, a wavelength-shifting filter, and a photosensor adjacent the screening region and operable to emit sensor signals from wavelength-shifted light received through the wavelength-shifting filter from interaction of the modulated light with the people or objects in the screening region.

In a further embodiment of any of the foregoing embodiments, the wavelength-shifting filter is one or more of a quantum dot filter, a sealed-gas-element filter, a metamaterial filter, and a metasurface filter.

In a further embodiment of any of the foregoing embodiments, the wavelength-shifting filter is the sealed-gas element, and the sealed-gas element includes a charged gas sealed between two plates.

In a further embodiment of any of the foregoing embodiments, the gas is pyrene or pyridine.

The system as recited in claim 1, further comprising a focusing lens, wherein the photosensor is situated to receive the wavelength-shifted light through the focusing lens.

In a further embodiment of any of the foregoing embodiments, the wavelength-shifting filter is one of a frequency upconverting filter and a frequency down-converting filter.

In a further embodiment of any of the foregoing embodiments, the photosensor is a color sensor that is responsive to at least one color spectral region.

In a further embodiment of any of the foregoing embodiments, the photosensor is a long wave infrared sensor.

The system as recited in claim 1, further comprising a controller electrically connected with the photosensor and the modulated light source, the controller configured to determine whether a target species is present in the screening region based on the sensor signals.

In a further embodiment of any of the foregoing embodiments, the controller includes a pulse generator and is configured to operate the modulated light source according to one or more of a random pulse pattern and a designed pulse pattern generated by the pulse generator.

A screening method according to an example of the present disclosure includes modulating light into a screening region through which people or objects move to produce process light off of the people or objects, wavelength-shifting the process light to produce wavelength-shifted light, generating sensor signals from the wavelength-shifted light using a photosensor, and determining whether a target species is present in the screening region based on the sensor signals.

A further embodiment of any of the foregoing embodiments includes wavelength-shifting the process light using one or more of a quantum dot filter a sealed-gas-element filter, a metamaterial filter, and a metasurface filter

A further embodiment of any of the foregoing embodiments includes one of frequency upconverting the process light and frequency down-converting the process light.

In a further embodiment of any of the foregoing embodiments, the photosensor is a color sensor that is responsive to at least one color spectral region.

In a further embodiment of any of the foregoing embodiments, the photosensor is a long wave infrared sensor.

A method for installing a screening system according to an example of the present disclosure includes mounting a modulated light source in a position to emit light into a screening region through which people or objects move, and mounting a photosensor and a wavelength-shifting filter adjacent the screening region such that the photosensor can receive process light through the wavelength-shifting filter from interaction of the light with the people or objects in the screening region.

In a further embodiment of any of the foregoing embodiments, the wavelength-shifting filter one or more of a quantum dot filter, a sealed-gas-element filter, a metamaterial filter, and a metasurface filter.

A method for monitoring a screening region according to an example of the present disclosure includes generating a pulse pattern, modulating a light source according to the pulse pattern to emit modulated light into a screening region to produce process light coming off of one or more objects within the screening region, recording sensor signals from at least a portion of the process light, performing one or more of correlation and convolution between the sensor signals and the pulse pattern or a designed pattern to produce a process signal, and determining whether a target species is present in the screening region based on the process signal.

In a further embodiment of any of the foregoing embodiments, the modulated light varies in one or more of intensity, pulse duration, and inter-pulse interval.

A further embodiment of any of the foregoing embodiments includes, prior to recording the sensor signals, wavelength-shifting the process light.

In a further embodiment of any of the foregoing embodiments, wavelength-shifting the process light using a quantum dot filter or a sealed-gas element.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example screening system.

FIG. 2 illustrates an example of synchronization of a random light pulse pattern with sensor signals to enhance signal-to-noise ratio.

FIG. 3 illustrates an example sealed-gas element wavelength-shifting filter.

### DETAILED DESCRIPTION

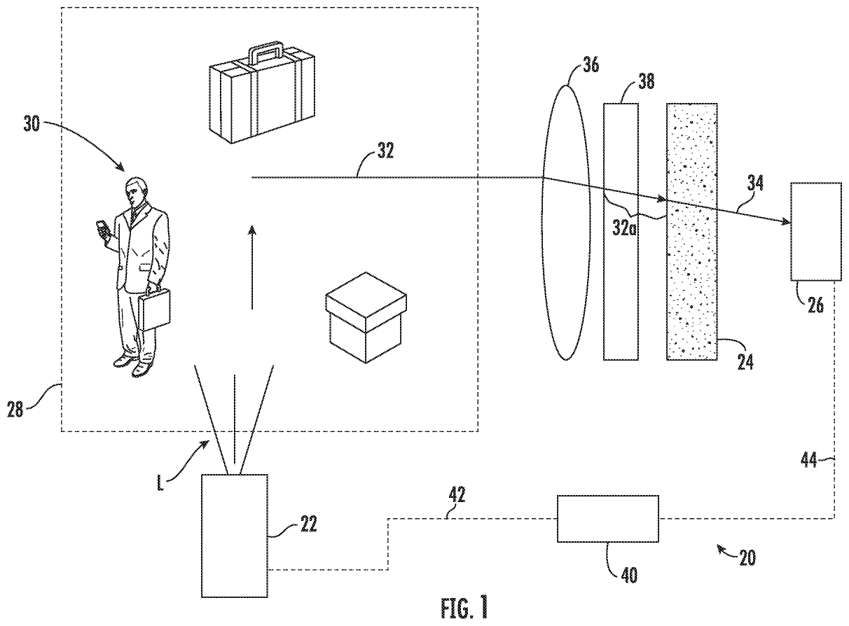

FIG. 1 schematically illustrates an example screening system 20 (“system 20”). As will be appreciated from the examples herein, the system 20 can provide a rapid, efficient, compact, accurate, and cost-effective approach for detecting weapons and trace chemicals.

The system 20 includes a modulated light source 22, a wavelength-shifting filter 24, and a photosensor 26. The modulated light source 22 may be a light emitting diode (LED) and is operable to emit light L at one or more selected wavelengths or bands into a screening region 28 through which people or objects 30 move. As an example, the screening area may be, but is not limited to, a checkpoint at an airport, concert, sporting event, warehouse, or port. The size of the screening region 28 may be varied. In one example, the screening region 28 may be about 30 square feet to about 1000 square feet. In further examples, the screening region 28 may be 50 square feet to about 400 square feet. The modulation may include one or more of amplitude modulation, frequency modulation, and temporal modulation, e.g., pulse duration and inter-pulse interval.

The photosensor 26 is located adjacent the screening region 28. For instance, the photosensor 26 can be in or partially in the screening area or near the screening area such that it can receive light that is scattered or emitted (collectively “process light 32”) from the people or objects 30 moving through the screening area. As examples, the photosensor 26 is a color sensor (RGB sensor), near infrared (NIR), midwave infrared (MWIR), long wave infrared sensor (LWIR), or ultraviolet (UV) sensor. In general, light source 22 and photosensor 26 may operate at any wavelength, set of wavelengths, continuous band of wavelengths, of set of bands of wavelengths in the electromagnetic spectrum. The wavelengths or bands of operation for light source 22 and photosensor 26 need not be the same.

The wavelength-shifting filter 24 is positioned such that the photosensor 26 receives at least a portion of the process light 32 through the wavelength-shifting filter 24. The wavelength-shifting filter 24 may convert at least a portion of the process light 32 to wavelength-shifted light 34. The photosensor 26 is operable to emit sensor signals responsive to the wavelength-shifted light 34.

In this example, the wavelength-shifting filter 24 is a quantum dot filter. The quantum dot filter may shift a short wavelength of light to a lower-energy, longer wavelength in a process called a Stokes shift or may shift a longer wavelength to a higher-energy, shorter wavelength in a process called an anti-Stokes shift. Wavelength-shifting filter 24 absorbs process light 32 at one or more frequencies and reemits wavelength-shifted light 34 at one or more different frequencies. In this manner, wavelength-shifting filter 24 may make process light 32 detectable by photosensor 26 whereby photosensor 26 has desirable properties such as high sensitivity, small size, and low cost. The wavelength-shifting filter 24 may further provide wavelength selectivity to, in essence, filter out wavelengths that deviate from the stimulation wavelength. As explained elsewhere herein, this can then be used to identify the presence of a target species in the screening region 28. In another example, the wavelength-shifting filter 24 is a non-linear optical wavelength-shifting metamaterial or metasurface as known in the art. The metamaterial or metasurface may comprise a stacked heretostructure with outer patterned surfaces to create coupled quantum wells. Adjusting the number of layers, their thicknesses, and surface patterning allows selective conversion of one light frequency into another.

In one example, the system 20 also includes a focusing lens 36 and background filter 38. For example the background filter 38 blocks wavelengths below 3 micrometers and above 15 micrometers so only long wavelength photons from 3 to 15 micrometers can pass through. The photosensor 26 is situated to receive the process light 32 through the focusing lens 36 and background filter 38.

A controller 40 is electrically connected at 42 with the light source 22 and at 44 with the photosensor 26. It is to be understood that electrical connections or communications herein can refer to optical connections, wire connections, wireless connections, or combinations thereof. The controller 40 is configured to determine whether a target species is present in the screening region 28 based on the sensor signals. This determination is based on the premise that the stimulation wavelength is characteristic of a type of the target species. Thus, receipt of photons of the stimulation wavelength (emitted from a surface of a material in the screening region 28) in the wavelength-shifting filter 24 and subsequent input of the wavelength-shifted light 34 to the photodetector 26 is used to identify that the target species is present in the screening region 28. The controller 40 may detect or determine that a target species is present by analysis of sensor signals. The analysis may consist of using a deep learning classifier trained from available data, such as a library of user characterized examples, by using statistical estimation algorithms, and the like. Deep learning is the process of training or adjusting the weights of a deep neural network. In one example, the deep neural network is a deep convolutional neural network. Deep convolutional neural networks are trained by presenting sensor signals to an input layer and, a present/absent label (optionally, a descriptive label, e.g., the specific species or obscurant), to an output layer. The training of a deep convolutional network proceeds layer-wise and does not require a label until the output layer is trained. The weights of the deep network's layers are adapted, typically by a stochastic gradient descent algorithm, to produce a correct classification. The deep learning training may use only partially labeled data, only fully labeled data, or only implicitly labeled data, or may use unlabeled data for initial or partial training with only a final training on labeled data. In another example, statistical estimation or regression techniques to determine if a target species is present. Statistical estimation regression techniques can include principal components analysis (PCA), robust PCA (RPCA), support vector machines (SVM), linear discriminant analysis (LDA), expectation maximization (EM), Boosting, Dictionary Matching, maximum likelihood (ML) estimation, maximum a priori (MAP) estimation, least squares (LS) estimation, non-linear LS (NNLS) estimation, and Bayesian Estimation.

In one example, the screening region 28 is monitored for the target species on a surface of an object or person by actively illuminating the screening region 28 with midwave infrared (MWIR) light. For example, target species may have absorbance resonances in the MWIR range that can be used to identify the presence of that species (e.g., a carbon-hydrogen bond has an absorbance resonance at a wavelength of 3.3 micrometers). Using a photo-thermal detection approach, the light is absorbed by a target species at the absorbance resonance. The absorbed light (energy) is converted to heat, which increases the temperature of the target species. The increase in temperature shifts the peak of the black body radiation emitted from the target species. The absorbed energy causes an overall increase in spectral radiance which can be detected at any wavelength (compared to the emission before heating) by a camera, in particular a LWIR camera. This emitted light is then received as the process light 32 by lens 36. The filter 38 may block wavelengths in the process light 32 that are outside the wavelength range of interest for the target species to produce filtered process light 32a. For example, if the wavelength range of interest is 7-12 micrometers, the filter may block wavelengths outside of that range. The wavelength-shifting filter 24 thus receives only the filtered process light 32a that is within the range of interest. The wavelength-shifting filter 24 then shifts the wavelength of that light to produce the wavelength-shifted light 34.

The wavelength-shifted light 34 is received into the photodetector 26, which responds by producing sensor signals that are proportional in intensity to the intensity of the wavelength-shifted light 34. A density of states (DOS) profile for a quantum dot looks like an impulse or singularity. Thus, depending on the energy of the photon and position of the singularity, an increase or decrease in the light being emitted can occur. The tuning of the quantum dot material in the wavelength-shifting filter 24 to be near the singularity enables a small change in the energy level of the quantum dot via absorption of light to create a large change in emission. The quantum dot's composition, size, and shape play a role in determining the position of a singularity in the DOS profile that will give rise to a particular wavelength that will be absorbed or emitted by a quantum dot. In addition, an electrical bias can be applied to tune the singularity to a wavelength of interest. The controller 40 analyzes the sensor signals to identify the whether the target species is present in the screening region 28.

The modulation of light source 22 facilitates enhancement of signal-to-noise ratio for improved detection. For instance, the light L may be emitted into the screening region 28 with a transmitted pulse pattern, such as a random ON/OFF pulse pattern or a non-random, designed pulse pattern. The received sensor signals may be correlated or convolved with the transmitted (random or design) pulse pattern or a second designed pulse pattern based on the transmitted pattern, which produces a process signal. A correlation may be a cross-correlation (i.e., between two different signals) or an auto-correlation (i.e., between a signal and itself). A correlation for discrete signals is the inner product of two sequences at different offsets (lags). The discrete correlation of real signals f and g is

$$( f ★ g ) [ k ] {=}^{def} {\sum }_{i = - L}^{i = + L} f [ i ] g [ k + i ]$$

where “*” denotes the correlation operator, k denotes the offset (lag), and i ranges over the support of f. The discrete convolution of real signals f and g is

$$( f * g ) [ k ] {=}^{def} {\sum }_{i = - L}^{i = + L} f [ i ] g [ k - i ]$$

where “*” denotes the convolution operator, k denotes the offset (lag), and i ranges over the support off. In an auto-correlation, and for the pulse patterns considered here, there will always be a maximum value at an offset (lag) of zero. The correlation values at offsets other than zero are called sidelobes. A convolution for discrete signals is the same as a convolution except that one of the signals has been reversed in time. In one non-limiting embodiment, the designed pattern may be designed such that the process signal has desirable properties such as that the correlation or convolution amplitude is large when the patterns substantially overlap and is otherwise small. Small, in this case, may mean that a maximum or integrated sidelobe level is below a threshold. In this case, the design of a pattern based on the transmitted pulse pattern may be the result of an optimization where the objective function is the integrated sidelobe level of the convolution or correlation of the transmitted pattern and the designed pattern and the optimization is a minimization. Other design criteria may be used as objective functions or constraints in the optimization and include that the pattern bandwidth is below a threshold, that the peak power is minimized, and the like.

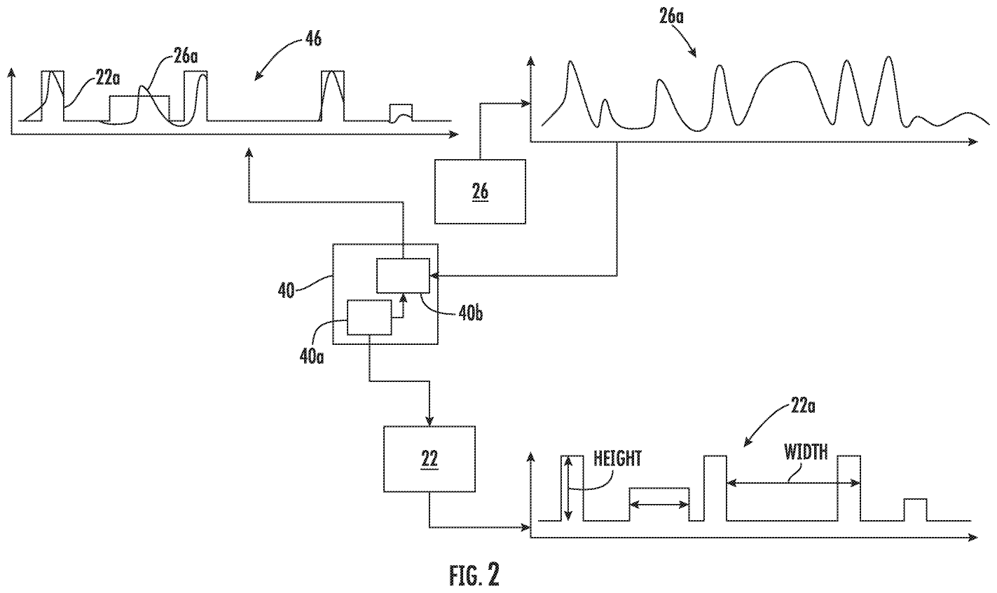

FIG. 2 demonstrates a further example of pulse compression by the controller 40. The controller 40 includes a random pulse generator 40a and a microprocessor 40b. The random pulse generator 40a may generate a random pulse pattern for the ON/OFF operation of the light source 22. The random pattern may be random with regard to light intensity and duration of ON and OFF periods. As an example, the light source 22 pulses with a pattern as represented at 22a (on the lower right of FIG. 2), wherein light intensity is on the Y-axis and time is on the X-axis, and “height” represents intensity and “width” represents duration. The random pulse generator 40a is also sent to the microprocessor 40b, which may include a memory for saving the pattern. Statistically, the random pattern has desirable correlation properties described elsewhere herein.

In response to the wavelength-shifted light 34 resulting from the emitted light pulses, the photodetector 26 generates sensor signals at 26a (on the upper right of FIG. 2), wherein light intensity is on the Y-axis and time is on the X-axis. The sensor signals are provided to the microprocessor 40b. The microprocessor 40b correlates the sensor signals 26a and the random pulse pattern 22a, graphically represented at 46 as sensor signals 26a superimposed on light pattern 22a. A correlation is the integral (if temporally continuous) or sum (if temporally discrete) of the product of the received sensor signal 26a with the transmitted pattern 22a. As can be seen graphically at 46, this correlation will be at a maximum at the overlap (time) shown and substantially smaller at any other overlap (time). Although small in size and useful for wavelength selectivity, quantum dot filters are subject to operational fluctuation due to changes in the temperature and conditions in the surrounding environment, resulting in noise within the signals received from them. By pulse compression using a designed pattern or the random pulse pattern, the controller 40 can discriminate noise portions of the sensor signal that are not from the emitted light pulses, greatly increasing the signal to noise of the data detected from the quantum dot filter.

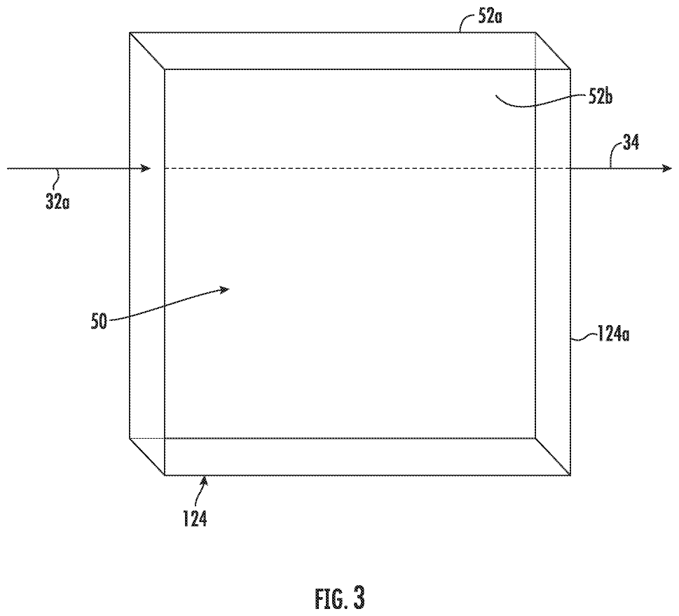

FIG. 3 illustrates another example of a wavelength-shifting filter 124 that can alternatively be used in the system 20 instead of the wavelength-shifting filter 24. In this example, the wavelength-shifting filter 124 is a sealed-gas element 124a. The sealed-gas element 124a includes a charged gas 50 sealed between two plates 52a, 52b. For example, the charged gas may be argon or neon. In other examples Pyrene or pyridine and their derivatives may be inserted in the sealed gas element 124a. Depending on the type, the charged gas 50 may be functional for wavelength shifting when the gas is at elevated temperatures and/or low pressure. In this regard, the charged gas 50 may be maintained at the elevated temperature and/or pressure, at least during use.

The process light 32 is transmitted through the sides of the sealed-gas element 124a and interacts with the charged gas 50. The charged gas 50 absorbs a portion of the process light 32 and, through a Stokes or anti-Stokes phenomenon, shifts the wavelength of the process light 32 to provide the wavelength-shifted light 34. The charged gas 50 operates similar to the quantum dots except that with gas the light always impinges the gas, whereas light can miss quantum dots. Additionally, the charged gas 50 does not require spatial registration as do quantum dots. Spatial registration between a quantum dot wavelength-shifting filter and an element of the photodetector 26 may be required based on the particle dimensions, size of the sensing elements of the photodetector 26, and the emission profile of the quantum dots. However, the charged gas 50 continuously distributes wavelength-shifted light, which eliminates the registration requirement.

The wavelength-shifting filter 24, 124 may be an upconverting filter that shifts the frequency of the process light 32 to a higher frequency. The higher frequency is achieved by electrically biasing the wavelength-shifting filter 24 or by the design of the metamaterial or metasurface. The electrical bias can be applied orthogonal to the light path to prevent obscuration of the incoming and emitting light. The photo-thermal approach with the wavelength-shifting filter 24 enables visible light cameras to be employed in the detection approach. As described elsewhere herein, light may be absorbed at a shorter wavelength resulting in heating which causes increased emission at other wavelengths. In particular, a longer wavelength light may interact with the wavelength-shifting filter, which responds by producing a visible light signal that is proportional in intensity to the intensity of the wavelength-shifted light 34. Converting in this manner enables use of a visible light photodetector for the photodetector 22, rather than a long wavelength detector. Long wavelength detectors can be more expensive. Additionally, a visible light detector enables use of three filters, one each for red, green, and blue. This in turn allows deeper spectral characterization, as well as higher resolution. This is because pixel density for visible cameras is higher and contains three wavelength sensitive elements per effective pixel, i.e. red, green, and blue elements. The higher pixel density enables better resolution, and comparison of the red, green, and blue elements provides characteristics of the emission profile of the wavelength-shifted light 34.

A visible light detector also permits greater data collection per unit of time. A wavelength shifting filter will have a lower quantum efficiency than a long wavelength detector. However, the loss of efficiency is traded for an increase in data acquisition speed. A long wavelength detector may have a capture rate of 20 frames per second, whereas a visible light detector may have capture rates or 120-1000 frames per second. With faster capture, more data per unit time can be collected for the screening region 28, which enhances capabilities and reliability.

The system 20 can rapidly screen the moving people or objects 30 and does so using standoff screening in the screening region 28. The standoff screening is achieved by active illumination with Near infrared, or infrared light of people and objects. Some of the process light 32 is then converted by the wavelength-shifting filter 24 or 124 into the visible spectrum for detection by the photodetector 26. In another example, the wavelength shifting filter is a frequency down-converting filter the light. This approach utilizes the position of the singularity that when a photon is absorbed a longer wavelength photon is emitted. This is applied to shift from NIR to LWIR, or UV to visible, based on quantum dot material selection or metamaterial/metasurface design. The system 20 can rapidly screen the people and objects 30, because no contact between the system components and people/objects is made, thereby removing a step in the current screening process to reduce wait-time.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A screening system comprising:
a modulated light source operable to emit light into a screening region through which people or objects move;
a wavelength-shifting filter; and
a photosensor adjacent the screening region and operable to emit sensor signals from wavelength-shifted light received through the wavelength-shifting filter from interaction of the modulated light with the people or objects in the screening region.

2. The system as recited in claim 1, wherein the wavelength-shifting filter is one or more of a quantum dot filter, a sealed-gas-element filter, a metamaterial filter, and a metasurface filter.

3. The system as recited in claim 2, wherein the wavelength-shifting filter is the sealed-gas element, and the sealed-gas element includes a charged gas sealed between two plates.

4. The system as recited in claim 3, wherein the gas is pyrene or pyridine.

5. The system as recited in claim 1, further comprising a focusing lens, wherein the photosensor is situated to receive the wavelength-shifted light through the focusing lens.

6. The system as recited in claim 1, wherein the wavelength-shifting filter is one of a frequency upconverting filter and a frequency down-converting filter.

7. The system as recited in claim 1, wherein the photosensor is a color sensor that is responsive to at least one color spectral region.

8. The system as recited in claim 1, wherein the photosensor is a long wave infrared sensor.

9. The system as recited in claim 1, further comprising a controller electrically connected with the photosensor and the modulated light source, the controller configured to determine whether a target species is present in the screening region based on the sensor signals.

10. The system as recited in claim 9, wherein the controller includes a pulse generator and is configured to operate the modulated light source according to one or more of a random pulse pattern and a designed pulse pattern generated by the pulse generator.

11. A screening method comprising:
modulating light into a screening region through which people or objects move to produce process light off of the people or objects;
wavelength-shifting the process light to produce wavelength-shifted light;
generating sensor signals from the wavelength-shifted light using a photosensor; and
determining whether a target species is present in the screening region based on the sensor signals.

12. The method as recited in claim 12, including wavelength-shifting the process light using one or more of a quantum dot filter a sealed-gas-element filter, a metamaterial filter, and a metasurface filter

13. The method as recited in claim 12, including one of frequency upconverting the process light and frequency down-converting the process light.

14. The method as recited in claim 12, wherein the photosensor is a color sensor that is responsive to at least one color spectral region.

15. The method as recited in claim 12, wherein the photosensor is a long wave infrared sensor.

16. A method for installing a screening system, the method comprising:
mounting a modulated light source in a position to emit light into a screening region through which people or objects move; and
mounting a photosensor and a wavelength-shifting filter adjacent the screening region such that the photosensor can receive process light through the wavelength-shifting filter from interaction of the light with the people or objects in the screening region.

17. The method as recited in claim 17, wherein the wavelength-shifting filter one or more of a quantum dot filter, a sealed-gas-element filter, a metamaterial filter, and a metasurface filter.

18. A method for monitoring a screening region, the method comprising:
generating a pulse pattern;
modulating a light source according to the pulse pattern to emit modulated light into a screening region to produce process light coming off of one or more objects within the screening region;
recording sensor signals from at least a portion of the process light;
performing one or more of correlation and convolution between the sensor signals and the pulse pattern or a designed pattern to produce a process signal; and
determining whether a target species is present in the screening region based on the process signal.

19. The method as recited in claim 19, wherein the modulated light varies in one or more of intensity, pulse duration, and inter-pulse interval.

20. The method as recited in claim 20, further comprising, prior to recording the sensor signals, wavelength-shifting the process light.

21. The method as recited in claim 21, including wavelength-shifting the process light using a quantum dot filter or a sealed-gas element.
